(19) United States
(12) Patent Application Publication
(10) Pub. No.: US 2004/0085324 A1
(43) Pub. Date: May 6, 2004

(54) Image-adjusting system and method

(75) Inventor: Yu-Sheng Yao, Hsin Tien (TW)

Correspondence Address: BRUCE H. TROXELL, SUITE 1404, 5205 LEESBURG PIKE, FALLS CHURCH, VA, 22041, US

(73) Assignee: REALLUSION INC.

(21) Appl. No.: 10/692,818

(22) Filed: Oct. 27, 2003

(30) Foreign Application Priority Data
Oct. 25, 2002 (TW) 91124925

(51) Int. Cl. G09G 5/00

(52) U.S. Cl. 345/581

(57) ABSTRACT

The present invention relates to an image-adjusting system and method, and more particularly, to a system and method for adjusting a facial image. By a set of adjusting parameters that by using a face-adjusting template stored in a database of face-adjusting template to adjust the image data of a facial image, wherein the database of face-adjusting template comprises plural data of face adjustment parameter generated by computer software or manual adjustment, such as skin texture, proportion of facial features, and variations of expression, etc., for improving the quality of a facial image, moreover, the arrangement and combination of the plural face adjustment parameters can further constitute different face-adjusting templates, so that the facial expression may be appropriately modified to generate the effect of different facial images.

### FIELD OF THE INVENTION

The present invention relates to an image-adjusting system and method, more particularly, to a system and method for adjusting the image of a facial image that is capable of adjusting the image data of a facial image by adapting face adjustment parameters.

### BACKGROUND OF THE INVENTION

‘Image’, which may be a universal available product or may be an expensive creation of art, is a ‘pattern symbol’ of international recognition without the need of any language annotation. All over the world, there are many hobbyists that are continuously and constantly taking pictures. Among them, some for recording their surrounding, some take it as interest, or as recreation, and some are so specialized that even become professional specialists, famous experts, and great masters.

General speaking, digital image is easier to be modified and finished using tools of image processing software comparing to traditional photograph, and is more flexible in application. Following the development and population of digital image processing technique, the consumer's demand and preference toward digital image products are increasing day by day, moreover, the related industry of digital image is also rigorously developed. Therefore, Digital image products have become one of the mainstreams of digital consumer goods.

Both the academic institutions and industry have continuously pouring R&D resources into the improvement of photograph hardware for fetching a better image, or into the advance and refinement of image processing algorithm for obtaining maximal operation flexibility and optimal image quality.

Digital image technique has evolved into professional application from the laboratory usage, and has further entered into the living of general public from the professional field. In this regard, except for the requirement of function and quality, friendly learning and using are the major requirements of the application tool used by the general public. Thus, the tool that can possesses qualities of intelligence and automation is becoming important edge of competition, and is the technique development focus point and trend for the next generation of digital image processing tool.

The traditional ways for processing the feature and expression of a facial digital image are as following:

1. Using image processing software (e.g., Photoshop) to modify the image manually: the tools of the image processing software, such as:

brush, filter, and deforming effect, etc., are adopted independently and successively for modifying a facial image. The major shortcoming of the foregoing method is that, since the method requires to operate the complicated image processing tools repetitiously, the user must be a professional that is skilled in the all functions of the image processing software and possesses the discipline of esthetics. Furthermore, all operation procedures are manually operated and can not be reserved, so that each image must be processed individually.

2. Processing an interpolation of image morph using an original photo and another photo to generate a new intermediate image (e.g., Morpheus software). The major shortcoming thereof is that two photos are needed for employing as generic images and, if the two photos are not of the same person, the dissimilation caused by the deforming process will be unacceptable.

Therefore, aim for solving the aforesaid problems, a novel facial image adjusting method, which not only is able to reduce the need of using complicated image processing tools, but also is able to use preset values repetitiously, is a long-term expectation of users and is also a lingering thought of the inventor. Based upon many years' engagement in the research, development, and marketing of the related products, along with the devotion of professional knowledge, research design, and special topic investigation, the inventor has finally worked out an improving method for adjusting facial image, so that the aforementioned problems can be solved.

### SUMMARY OF THE INVENTION

The main objective of the present invention is to provide an image-adjusting system and method, more particularly, to provide a system and method for adjusting a facial image that by using a face-adjusting template stored in a database of face-adjusting template to adjust the image data of a facial image, wherein the database of face-adjusting template comprises plural data of face adjustment parameter, such as skin texture, proportion of facial features, and variations of expression, etc., for improving the quality of a facial image, moreover, the arrangement and combination of the plural face adjustment parameters can further constitute different face-adjusting templates. Thus, an operation of applying the aforesaid templates on the facial image intended to be process can be used for replacing traditional complicated image processing techniques.

The secondary objective of the present invention is to provide an image-adjusting system and method, more particularly, to provide a system and method for adjusting a facial image that by using a face-adjusting template stored in a database of face-adjusting template to adjust the image data of a facial image, wherein the face-adjusting template stored in the database can be used repetitiously, and can be applied in a facial image processing directly after selection so that the operation time for image processing is shorten, furthermore, users of the present invention do not requires to possess any professional skill of visual design and computer graphics.

Yet, another objective of the present invention is to provide an image-adjusting system and method, more particularly, to provide a system and method for adjusting a facial image that by using a face-adjusting template stored in a database of face-adjusting template to adjust the image data of a facial image, wherein the database of face-adjusting template comprises a plurality of face-adjusting templates that are generated by computer software or by manual adjustment, and the plural face-adjusting templates comprising adjustment parameters for removing skin blemishes, adjustment parameters for facial feature proportion, and adjustment parameters for adjusting facial expression, so that the facial image may be modified appropriately to generate different facial effects.

Yet, another objective of the present invention is to provide an image-adjusting system and method, more particularly, to provide a system and method for adjusting a facial image. Wherein, the method of the present invention integrates the techniques of image filtering, local deformation, and muscle simulation, etc. to adjust the facial image. The filter technique is used to adjust the skin texture for a more healthy appearance, such as: removing fleck, wrinkle, and scar. The local deformation technique is used for adjusting the proportion and shape of face and facial features. The muscle simulation technique is based upon the anatomy of face and uses the interaction of muscle to perform facial expression adjustment for showing different personality. The adjustment parameter values obtained using the aforesaid image processes are stored in a face-adjusting template database that can be chosen at any time to apply on a facial image, thus, the effect and speed in the facial image processing can be greatly improved.

### BRIEF DESCRIPTION OF THE DRAWINGS

Following drawings are cooperated to describe the detailed structure and its connective relationship according to the invention for facilitating your esteemed members of reviewing committee in understanding the characteristics and the objectives of the invention.

FIG. 1 is a block diagram depicting a system framework of the present invention.

FIG. 2 is a flowchart for processing an image according to the present invention.

FIG. 3A and FIG. 3B illustrate a preferred embodiment of the present invention.

FIG. 4A and FIG. 4B illustrate another preferred embodiment of the present invention.

FIG 5A and FIG. 5B illustrate yet another preferred embodiment of the present invention.

FIG. 6 illustrate yet another preferred embodiment of the present invention showing a dynamic series of facial expression variations.

FIG. 7 illustrate yet another preferred embodiment of the present invention showing a facial image of animated comic effects.

### DETAILED DESCRIPTION OF THE INVENTION

For your esteemed members of reviewing committee to further understand and recognize the fulfilled functions and structural characteristics of the invention, several preferred embodiments cooperating with detailed description are presented as the follows.

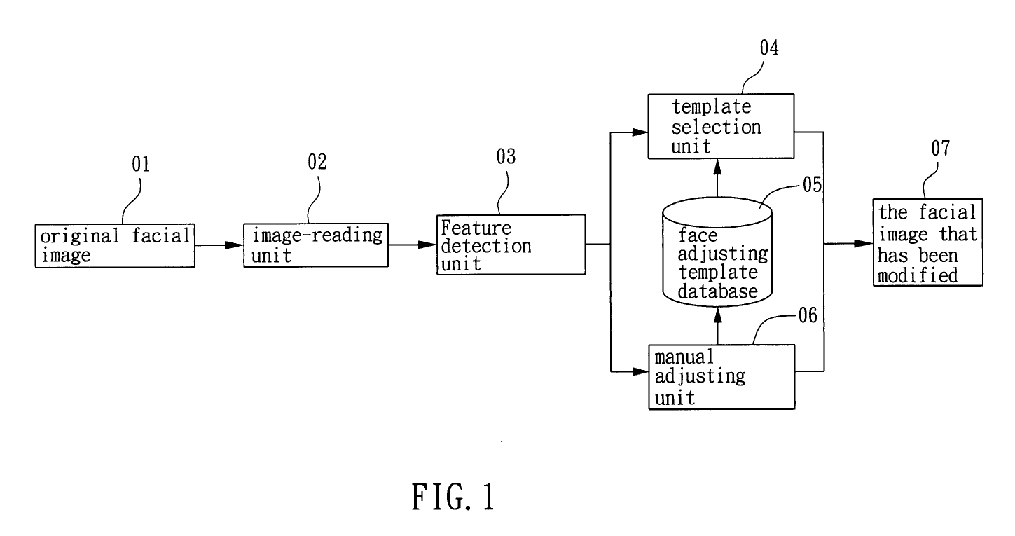

Please refer to FIG. 1, which is a block diagram depicting a system framework of the present invention. As seen in FIG. 1, the image-adjusting system of the present invention comprises: an image-reading unit 02, a feature detection unit 03, a template selection unit 04, a face-adjusting template database 05, and a manual adjusting unit 06. The image-reading unit 02 in the image-adjusting system of the present invention first reads an original facial image 01, after which is characteristically recognized by the feature detection unit 03 (detailed steps will be described thereinafter) so as to accomplish the positioning of the relevant facial characteristics. Thereafter, user may pick up a set of face-adjusting template (wherein, the face-adjusting template is composed of a plurality of face adjustment parameters) from the face-adjusting template database 05 using the template selection unit 04 of the present invention for adjusting the characteristic-positioned facial image 01, such as: enabling a smile, so that a completely adjusted facial image 07 is obtained.

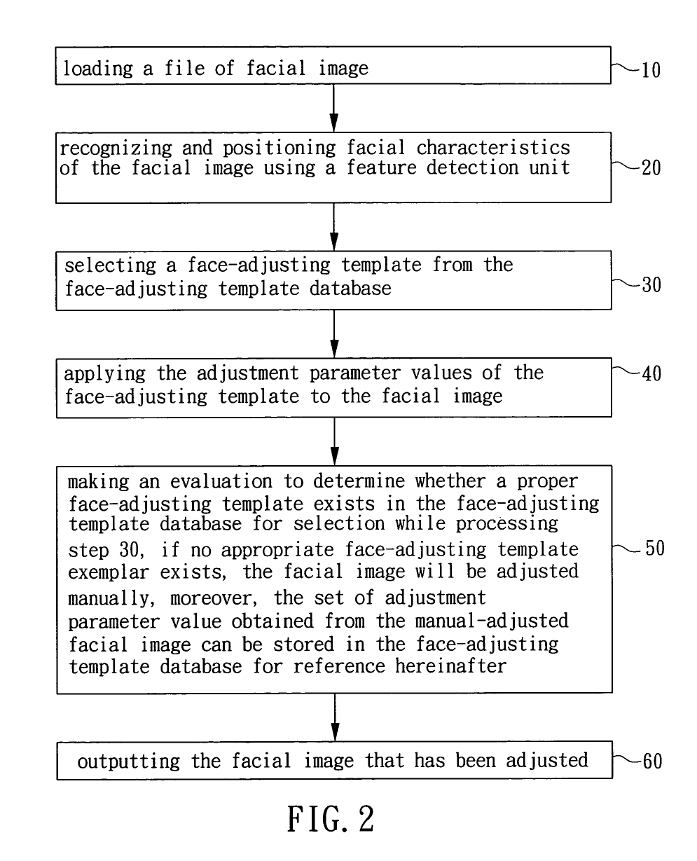

Please refer to FIG. 2, which is a flowchart for the image process according to the present invention, comprising at least the following steps:

Step 10: loading a file of facial image;

Step 20: recognizing and positioning facial characteristics of the facial image using a feature detection unit;

Step 30: selecting a face-adjusting template from the face-adjusting template database;

Step 40: applying the adjustment parameter values of the face-adjusting template to the facial image;

Step 50:making an evaluation to determine whether a proper face-adjusting template exists in the face-adjusting template database for selection while processing step 30, if no appropriate face-adjusting template exists, the facial image will be adjusted manually, moreover, the set of adjustment parameter value obtained from the manual-adjusted facial image can be stored in the face-adjusting template database for adjustment hereinafter; and

Step 60: outputting the facial image that has been adjusted.

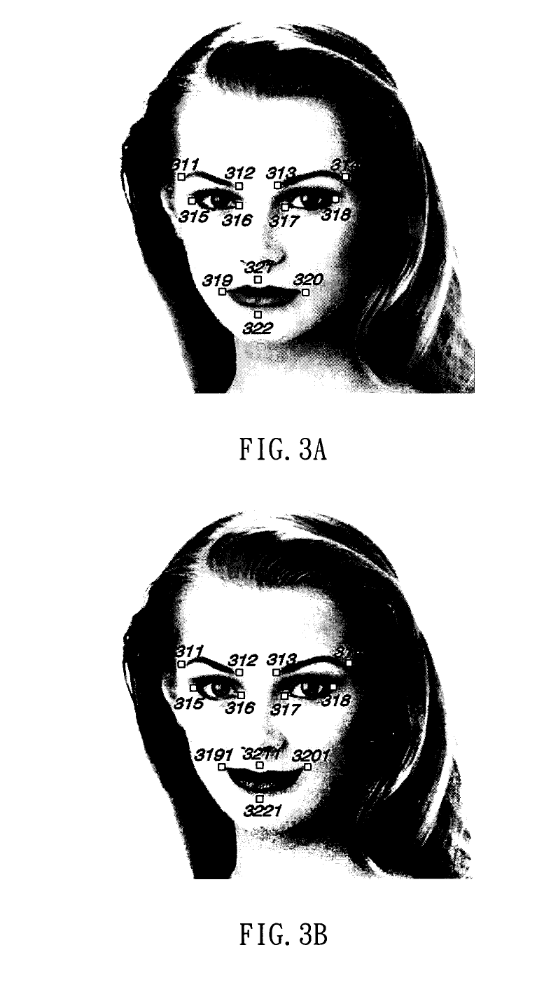

Please refer to FIG. 3A and FIG. 3B, which is a schematic diagram showing an actual operation for a preferred embodiment of the present invention. As shown, after a facial image is loaded into the system of the present invention, the image-recognizing unit in the system will first recognize and position the facial characteristics of the facial image, and thereafter the positions of the facial features are obtained so as to locating singular points of the facial features using the analysis and calculation basing on the facial characteristics of the facial image, furthermore, the set of the singular points of facial features are used to construct a set of structural diagrams matching the facial characteristics, that the facial image is then divided into several zones according to the facial features. Please refer to FIG. 3A for the characteristic-recognized facial image. As shown in FIG. 3A, the image-recognizing unit recognizes and positions the facial characteristics including eyebrow-positioning points 311, 312, 313, and 314, eye-positioning points 315, 316, 317, and 318, and mouth-positioning points 319, 320, 321, and 322. Thereafter, a template selection unit 04 of the present invention is used for selecting the template having image of intended adjustment. Taking the present embodiment as an example, if the intended image is ‘smile’, then a ‘smile’ face-adjusting template is selected from a face-adjusting template database 05 in the system of the invention, and the ‘smile’ face adjustment parameters are applied to the facial image so as to modify the facial image. The modified facial image is shown as FIG. 3B. As shown in FIG. 3B, the original mouth-positioning points 319, 320, 321, and 322 will become the new mouth-positioning points 3191, 3201, 3211, and 3221, so that the facial image now looks like ‘smile’. If the user is unsatisfied with the modified facial image, then the user may use a manual adjusting unit of the present invention for fine-tuning the facial image to a satisfactory degree. Thereafter, the ‘smile’ facial image is ready for the next processing steps, such as: sending the ‘smile’ facial image to a faraway friend using mobile phone.

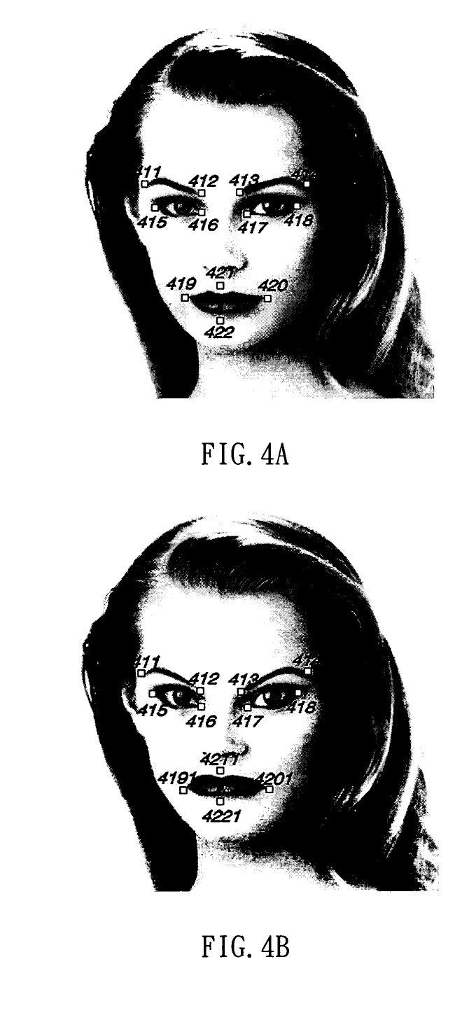

Please refer to FIG. 4A and FIG. 4B, which is a schematic diagram showing an actual operation for another preferred embodiment of the present invention. As shown, after a facial image is loaded into the system of the present invention, the image-recognizing unit in the system will first recognize and position the facial characteristics of the facial image, and thereafter the positions of the facial features are obtained so as to locating singular points of the facial features using the analysis and calculation basing on the facial characteristics of the facial image, furthermore, the set of the singular points of facial features are used to construct a set of structural diagrams matching the facial characteristics, that the facial image is then divided into several zones according to the facial features. Please refer to FIG. 4A for the characteristic-recognized facial image. As shown in FIG. 3A, the image-recognizing unit recognizes and positions the facial characteristics including eyebrow-positioning points 411, 412, 413, and 414, eye-positioning points 415, 416, 417, and 418, and mouth-positioning points 419, 420, 421, and 422. Thereafter, a template selection unit of the present invention is used for selecting the image of intended adjustment. Taking the present embodiment as an example, if the intended image is ‘anger’, then an ‘anger’ face-adjusting template is selected from a face-adjusting template database in the system of the invention, and the ‘anger’ face adjustment parameters are applied to the facial image so as to modify the facial image. The modified facial image is shown as FIG. 4B. As shown in FIG. 4B, the original mouth-positioning points 419, 420, 421, and 422 will become the new mouth-positioning points 4191, 4201, 4211, and 4221, so that the facial image now looks like ‘anger’. If the user is unsatisfied with the modified facial image, then the user may use a manual adjusting unit of the present invention for fine-tuning to the facial image to a satisfactory degree. Thereafter, the ‘anger’ facial image is ready for the next processing steps, such as: sending the ‘anger’ facial image to a faraway friend using mobile phone.

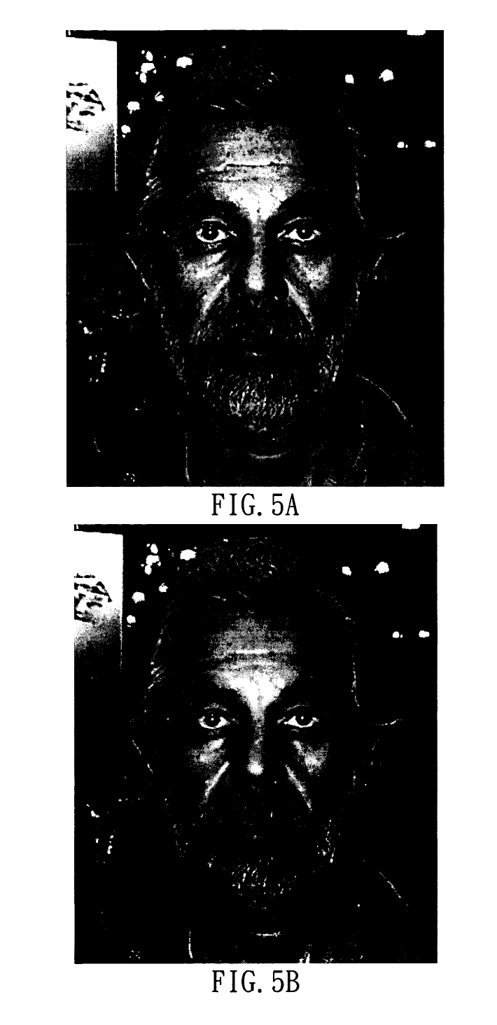

The present invention may, through a preset face-adjusting template, perform many different kinds of adjusting process to a facial image. For example, except for modifying the shape of each feature on the facial image through the preset face-adjusting template with reference to the aforementioned embodiments, it is also possible to modify the smoothness and color of the skin of a facial image through a preset face-adjusting template. Please refer to FIG. 5A and FIG. 5B, which are afore-adjusting and after-adjusting illustrations for another preferred embodiment of the present invention. As shown in the figure, filter technique is used for locally removing the skin's flaw and locally adjusting the skin's color while processing the image. That is, after the facial features had been recognized the positioned using the present invention, a face adjustment parameter values of the face-adjusting template stored in the face-adjusting template database are applied on the image so as to remove the unnecessary spots and lines on the facial image, while maintaining clarity of the facial features of the facial image. The result of this process is similar to the effect of local filter.

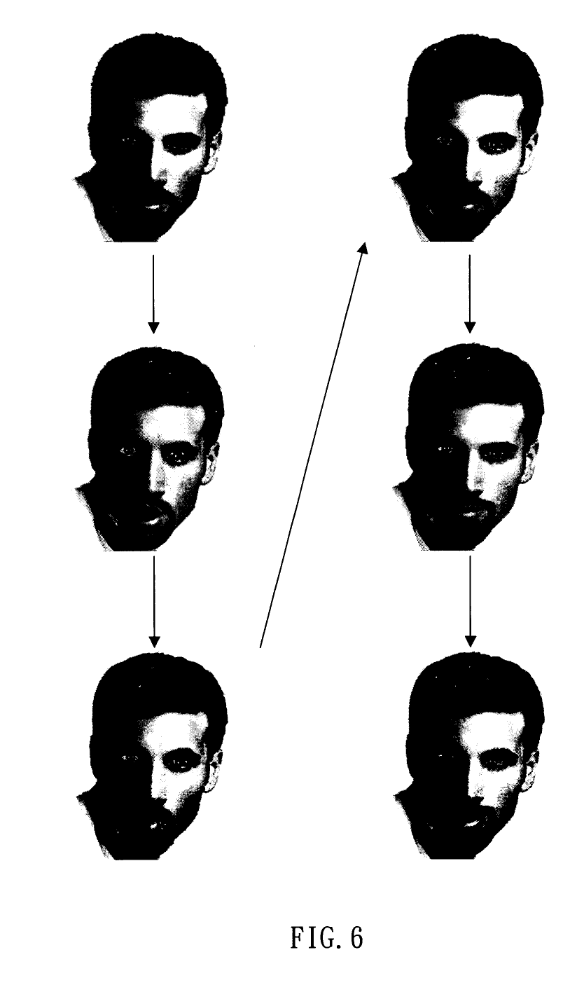

Yet, another preferred embodiment of the present invention, the face-adjusting template database may further include a template having an assortment of dynamical serial-connected facial variations, for example, as seen in FIG. 6, ‘Dynamic Variation of the Expression of Facial Feature’. These templates are shown by the manner of animation, which applies the variation of continuous interpolation between the face-adjusting templates and cooperates with Lip-Sync technique, so that a facial image can have vivid expression while talking.

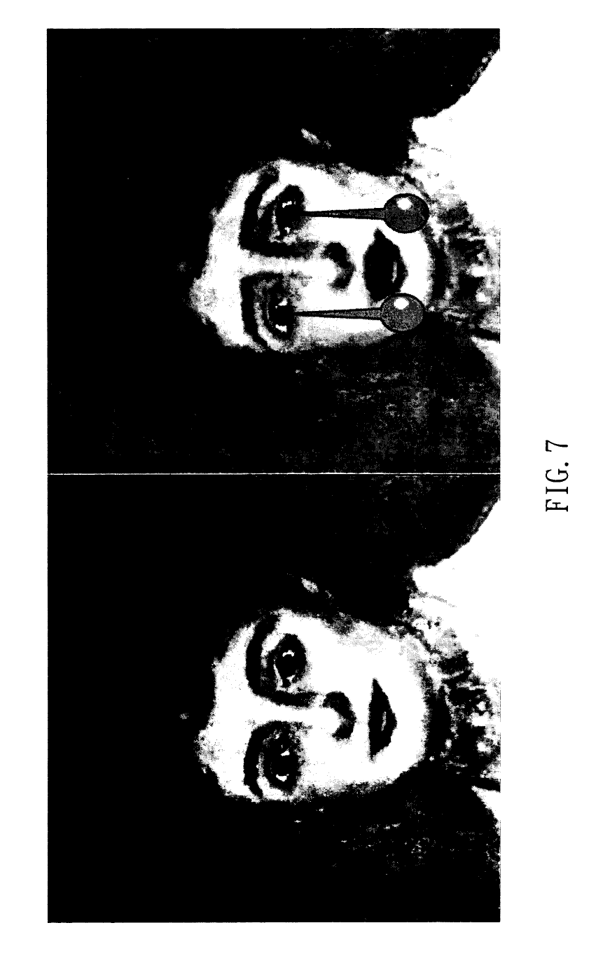

Further, another preferred embodiment of the present invention, the face-adjusting template database may further include an template of ‘Animated Comic Effect’, as seen in FIG. 7. The template is shown by the manner of animation, that the comic effect is drawn on the specific position of a facial feature. For example, when talking, adding tears glittering in the eyes, saliva dangling in the mouth corner, blue veins projecting from the forehead, etc. may exaggerate the sentiment and add more fun.

To sum up, the face-adjusting template database of the present invention may store large amount of different kinds of face-adjusting template in advance, including skin texture adjustment parameter, facial feature scaling parameter, facial feature measuring parameter, and facial expression reference parameter, etc. When processing an image, user may choose and apply a face-adjusting template previously stored in a face-adjusting template database onto a facial image so as to obtain a deformed or modified image rapidly. In this regard, the face-adjusting template previously stored in a face-adjusting template database of the present invention may be applied directly onto a facial image without any procedure operated by a professional of visual design or computer graphics, moreover, no complicated process needed to be operated on each image, so that the processing time of facial image may be saved, the operation of image processing is simplified, and the working efficiency is enhanced greatly.

However, the aforementioned description is only the preferred embodiments according to the present invention and, of course, can not be applied as a limitation to the field of the invention, and any equivalent variation and modification made according to the claims claimed thereinafter still possess the merits of the invention and are still within the spirits and the ranges of the invention, so they should be deemed as a further executing situation of the invention.

What is claimed is:

1. An image-adjusting system for facial image, comprising:
an image-reading unit, for reading an original facial image;
a feature detection unit, for recognizing and positioning facial characteristics of the facial image;
a face-adjusting template database, for storing a plurality of face-adjusting templates that are preset, wherein each different face-adjusting template further comprises different face adjustment parameters that are preset;
a template selection unit, for selecting a face-adjusting template having facial characteristic of intended adjustment from the face-adjusting template database, and the selected face-adjusting template is applied to the original facial image so as to modify the facial characteristic of the original facial image; and
a manual adjusting unit, which is used for adjusting the facial characteristic of the facial image manually, and may record a parameterized processing procedure and used as a new template, moreover, the new template is stored in the face-adjusting template database.

2. The image-adjusting system for facial image according to claim 1, wherein the facial characteristics of the facial i mage comprises the characteristic of the relative position and proportion of facial features of the facial image.

3. The image-adjusting system for facial image according to claim 1, wherein the facial characteristics of the facial image comprises the characteristic of the skin texture.

4. The image-adjusting system for facial image according to claim 1, wherein the preset face adjustment parameter can be a facial expression parameter of the facial image.

5. The image-adjusting system for facial image according to claim 1, wherein the preset face adjustment parameter can be a proportion parameter of facial feature of the facial image.

6. The image-adjusting system for facial image according to claim 1, wherein the preset face adjustment parameter can be a skin texture parameter.

7. The image-adjusting system for facial image according to claim 1, wherein the preset face adjustment parameter can be a skin parameter of brightness-and-contrast.

8. The image-adjusting system for facial image according to claim 1, wherein the preset face adjustment parameter can be a tint parameter of skin color.

9. The image-adjusting system for facial image according to claim 1, wherein the preset face-adjusting template can be a template having an assortment of dynamic series of facial expression variations.

10. The image-adjusting system for facial image according to claim 1, wherein the preset portrait image adjusting parameter can be a template of animated comic effect.

11. An image-adjusting method for facial image, comprising at least the following steps:
(a)loading a facial image;
(b)recognizing and positioning facial characteristics of the facial image using a feature detection unit;
(c)selecting a face-adjusting template from a face-adjusting template database;
(d)applying the adjustment parameter values of the selected face-adjusting template to the facial image for modifying the facial characteristics of the facial image;
(e)while processing step (c), making an evaluation to determine whether a proper face-adjusting template exists in the face-adjusting template database for selection, if no appropriate face-adjusting template exists, the facial image will be adjusted manually in step (c), moreover, a parameterized processing procedure is recorded and used as a new template, and the new template is stored into the face-template database;
(f)after processing step (d), adjusting the facial characteristics of the facial image manually can further be applied onto the modified facial image; and
(g)outputting the facial image that has been adjusted.

12. The image-adjusting method for facial image according to claim 11, wherein the preset face-adjusting template can be an assortment of facial expression parameters of the facial image.

13. The image-adjusting method for facial image according to claim 11, wherein the preset face-adjusting template can be an assortment of proportion parameters of facial feature of the facial image.

14. The image-adjusting method for facial image according to claim 11, wherein the preset face-adjusting template can be an assortment of skin texture parameters.

15. The image-adjusting method for facial image according to claim 11, wherein the preset face-adjusting template can be an assortment of skin parameters of brightness-and-contrast.

16. The image-adjusting method for facial image according to claim 11, wherein the preset face-adjusting template can be an assortment of tint parameters of skin color.

17. The image-adjusting method for facial image according to claim 11, wherein the preset face-adjusting template can be an assortment of dynamic series of facial expression variations.

18. The image-adjusting method for facial image according to claim 11, wherein the preset face-adjusting template can be an assortment of animated comic effects.
